(19) United States
(12) Patent Application Publication
(10) Pub. No.: US 2011/0033007 A1
(43) Pub. Date: Feb. 10, 2011

(54) MULTI-BAND, MULTI-DROP CHIP TO CHIP SIGNALING

(76) Inventors: Jared L. Zerbe, Woodside, CA (US); Vladimir M. Stojanovic, Lexington, MA (US); Ravindranath Kollipara, Palo Alto, CA (US); Wendemagegnehu Beyene, San Jose, CA (US); Amir Arnirkhany, Sunnyvale, CA (US); Bruno Garlepp, Sunnyvale, CA (US)

Correspondence Address: MAHAMEDI PARADICE KREISMAN LLP, 550 Winchester Boulevard, Suite 605, SAN JOSE, CA, 95128, US

(21) Appl. No.: 12/809,517

(22) PCT Filed: Nov. 12, 2008
(86) PCT No.: PCT/US08/83231

§ 371 Date: Oct. 28, 2010

Related U.S. Application Data
(60) Provisional application No. 61/015,117, filed on Dec. 19, 2007.

(51) Int. Cl. H04L 27/00

(52) U.S. Cl. 375/295

(57) ABSTRACT

A system comprising: a first integrated circuit device having a multi-band transmission circuit; second and third integrated circuit devices having respective multi-band reception circuits; and a signaling link including a first stub coupled to the multi-band transmission circuit to receive a multi-band signal therefrom, second and third stubs coupled to the multi-band reception circuits of the second and third integrated circuit devices, respectively, to deliver the multi-band signal thereto, and a plurality of channel segments that extend between the first, second and third stubs to convey the multi-band transmission signal therebetween, and wherein at least one of a physical length, impedance or propagation constant of at least one of the first stub, second stub, third stub or channel segment of the plurality of channel segments is selected to spectrally position a frequency-interval exhibiting attenuated frequency response on the signaling link such that multiple passbands separated by the frequency-interval are established to enable conveyance of the multi-band transmission signal on the signaling link.

### RELATED APPLICATIONS

This application claims priority to provisional U.S. Patent Application No. 61/015,117, filed 19 Dec. 2007, entitled “Multi-Band, Multi-Drop Chip to Chip Signaling,” the aforementioned application being hereby incorporated by reference in its entirety.

### TECHNICAL FIELD

The disclosure herein relates to signal transfer between and among integrated circuit devices.

### BACKGROUND

Master-slave integrated-circuit systems have traditionally been implemented using multi-drop signaling topologies, with a master device 101 driving a shared set of signaling lines 103, or bus, that is coupled in parallel to multiple slave devices 105. This approach permits an extensible number of devices to be attached to the shared bus, thus providing flexibility for system expansion.

Referring to FIG. 1A, a significant disadvantage of a multi-drop signaling topology is that the set of traces extending between each slave device and the shared bus (i.e., each “drop” along the multi-drop bus) increases the bus capacitance and also constitutes a stub 107, or impedance discontinuity, that reflects incoming signal wavefronts as shown at 109. Consequently, each additional slave connection along the multi-drop bus, increases both dispersion-type and reflection-type inter-symbol-interference (ISI) on the bus, thus decreasing the signaling margin (i.e., discernible difference in voltage, current or other signal characteristics used to distinguish between symbol values) and creating notches as shown in the frequency response plot of FIG. 1B, reducing the maximum practicable signaling frequency over the bus.

To keep pace with demands for ever-increased signaling bandwidth, system designers have turned to point-to-point signaling topologies to avoid interconnection stubs, and also, in multi-drop and point-to-point systems, to various equalization schemes that compensate for impedance discontinuities and other channel characteristics. Point-to-point signaling topologies involve dedicated signaling paths between each pair of ICs in a multi-chip (multiple IC) signaling system and thus, for a master device, effectively multiplies the number of I/O (input/output) pins by the number of slave devices to be supported by the system. Consequently, the increased signaling bandwidth achieved through cleaner signaling paths comes at the cost of significantly increased master-device I/O count (and interconnection resources such as traces on a printed circuit board) and, in most cases, reduced system expandability. On the other hand, equalization schemes tend to be complex and often cost prohibitive in master-slave systems that include a relatively high slave-to-master ratio (e.g., memory systems which often include 9 or 18 slave devices per memory module and thus as many as 36 or 54 slave devices per master device (memory controller)), as decision-feedback-equalization circuitry or the like must typically be included in each individual slave device. More generally, cost-effective equalization systems still tend to be limited by the location and magnitude of system notches.

### BRIEF DESCRIPTION OF THE DRAWINGS

The disclosure herein is illustrated by way of example, and not by way of limitation, in the figures of the accompanying drawings and in which like reference numerals refer to similar elements and in which:

FIG. 1A illustrates a prior-art signaling system having multiple integrated circuit devices coupled to a multi-drop bus;

FIG. 1B illustrates an exemplary frequency response of the signaling system of FIG. 1A;

FIG. 2A illustrates an embodiment of a multi-drop signaling system that may employ subchannel signaling;

FIG. 2B illustrates exemplary frequency response curves that apply to communications between selected pairs of integrated circuit devices within the system of FIG. 2A;

FIG. 2C illustrates exemplary frequency response curves that apply to communications between selected pairs of integrated circuit devices within the system of FIG. 2A after impedances, propagation constants and/or signal path lengths have been adjusted to achieve notch alignment;

FIG. 2D illustrates exemplary modifications to physical dimensions of the channel, and placement of one or more additional stubs to control notch frequency and thus enable notch alignment for a target frequency or set of frequencies as shown in FIG. 2C;

FIG. 3 illustrates an exemplary assignment of different bit-density signal encoding schemes to different subchannels within a subchannel signaling system;

FIG. 4 illustrates a pair of integrated circuit devices coupled to one another via a multi-drop bus and including a number of multi-band transmitters and counterpart multi-band receivers for communicating in one or more of three different passbands tuned to respective center frequencies;

FIGS. 5A-5E illustrate a number of possible virtual channel allocations in a multi-drop signaling system having a superchannel formed by multiple spectrally-defined subchannels and multiple spatially-defined subchannels; and

FIGS. 6A-6D illustrate exemplary multi-drop signaling systems in which subchannel signaling may be employed.

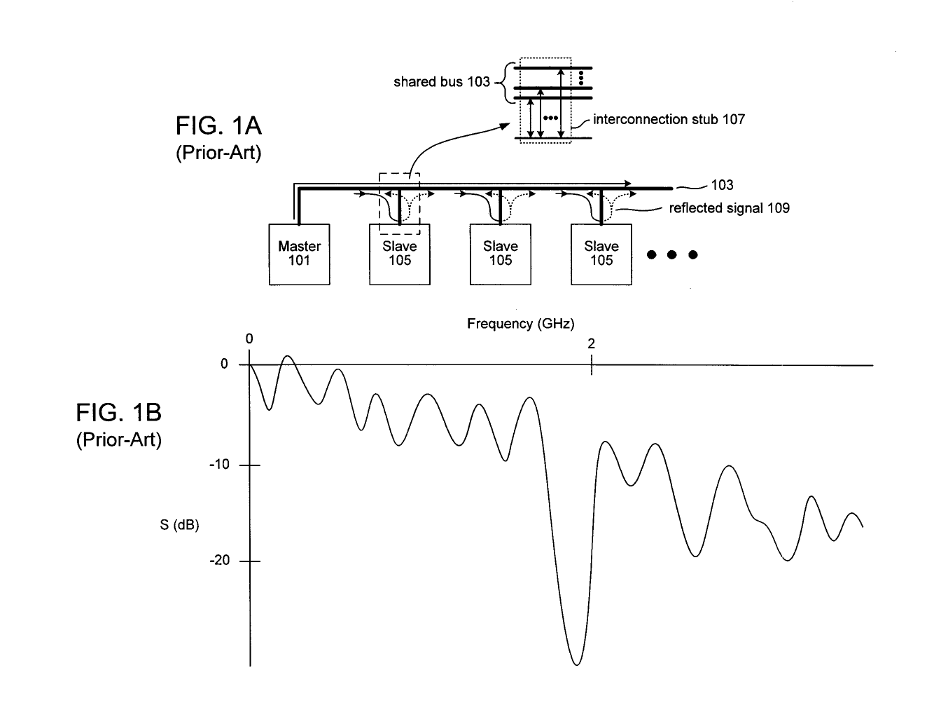

### DETAILED DESCRIPTION

A multi-drop signaling system in which the signal transmission spectrum is partitioned into multiple frequency bands or subchannels, each bounded by notches that result from interconnection stubs along the multi-drop signaling path, is disclosed in various embodiments. In a number of implementations, the interconnection stub lengths, and/or capacitive or inductive structures that form part of the interconnection stubs, are specifically sized or designed to achieve spectral alignment of otherwise frequency-offset notches, and thus establish relatively clear passbands and well-located isolation notches for subchannel signaling. When partitioned into notch-bounded subchannels in this manner, lower frequency, higher-margin subchannels may be used for signal encoding schemes having increased bit-to-symbol ratios (bit density) relative to higher-frequency, lower-margin subchannels, thereby achieving a bandwidth hierarchy that exploits the frequency response gradient from lower to higher frequency subchannels. More generally, location of notch frequencies can be selected to enable multi-band transmissions that achieve superior performance and/or lower implementation complexity than more conventional equalized single-band systems. In particular embodiments, for example, tuning of impedances, propagation constants and/or signal path lengths is carried out to create equally spaced notch frequencies that in turn enable efficient multi-band signaling. In yet other embodiments, arbitration schemes may be used to dynamically allocate the subchannels to different transmission sources (e.g., allocating subchannels to respective devices in a multiple-master system or master-slave system) and thus enable simultaneous bi-directional communications between master and slave, distinct, simultaneous communications to/from multiple slave devices, simultaneous communication from multiple master devices in a multiple-master signaling system. Also, two or more subchannels may be dynamically allocated to a given data transmission request, effectively ganging the subchannels to achieve a higher peak bandwidth than may be available over any single subchannel alone. Further, multi-drop topologies including, without limitation, ring topologies and tree topologies or any combination of such topologies may be employed in combination with the above-described subchanneling technique, with interconnection stub impedances designed to achieve a desired multiple-passband channel, with subchannel signaling carried out in individual or ganged passbands.

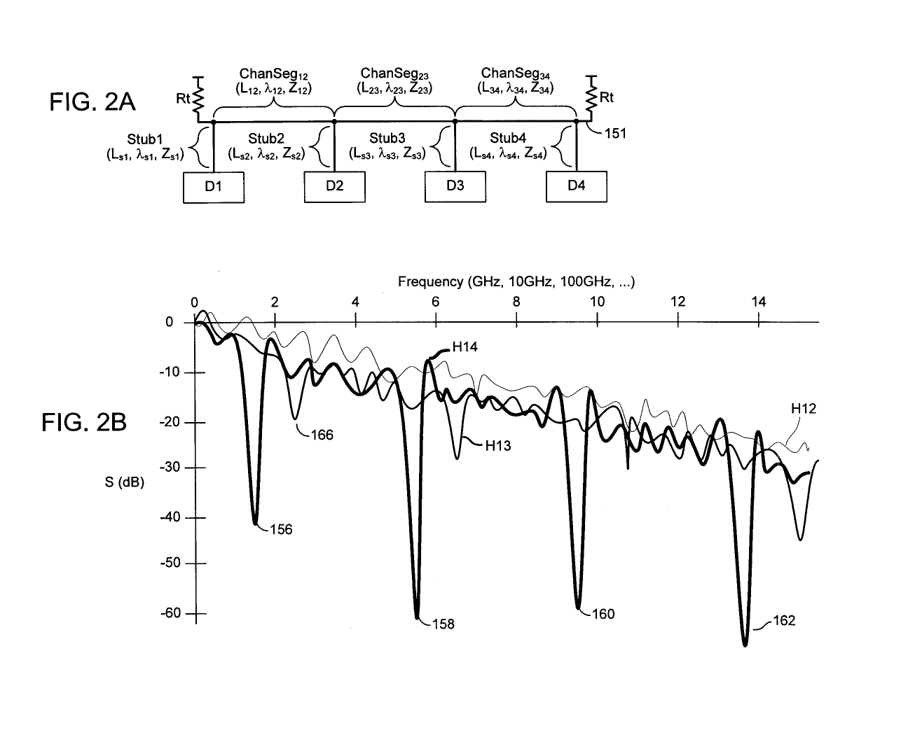

FIG. 2A illustrates an embodiment of a multi-drop signaling system that employs subchannel signaling. In the particular embodiment shown, each of multiple devices, D1-D4 (e.g., integrated circuit dice or chips), is coupled to a multi-drop bus 151 (i.e., shared set of signaling lines) by a respective set of lead-in signal lines referred to herein as the lead-in stub or stub (Stub1-Stub4). The multi-drop bus 151 is terminated at each end by a termination resistance, Rt, although a singly terminated (i.e., terminated at one location instead of at two locations in the doubly-terminated arrangement shown) or non-terminated bus may alternatively be used. Also, more or fewer devices may be coupled to the multi-drop bus 151 in alternative embodiments. The multi-drop bus 151 may be viewed as a composite of interconnected segments, including channel segments (ChanSeg₁₂, ChanSeg₂₃, ChanSeg₃₄) that extend between neighboring stubs, and the stubs themselves (Stub1-Stub4). Each of the channel segments and stubs may be characterized by a respective length (L₁₂, L₂₃, L₃₄ for the channel segments, L_{S1}-L_{S4} for the stubs), impedance (Z₁₂-Z₃₄ and Z_{S1}-Z_{S4}) and propagation constant (λ₁₂-λ₃₄ and)λ_{S1}-λ_{S4}).

Assuming for purposes of explanation that device D1 is a master device that communicates at various times with slave devices D2, D3 and D4, the different locations of the lead-in stubs relative to the device addressed (i.e., being communicated with) by the master device and the different number of bus segments traversed result in a different channel transfer function as shown in FIG. 2B. More specifically, when D1 is communicating with D2, the transfer function illustrated by frequency-response curve H12 applies, when D1 is communicating with D3, frequency-response curve H13 applies and when D1 is communicating with D4, frequency-response curve H14 applies. Note that the longer, higher attenuation path between devices D1 and D4, with two substantial reflection sources in lead-in stubs Stub2 and Stub3, yields a substantially increased drop or notch 156 in the transfer function, centered around 1.8 GHz. Other notches in H14 (158, 160, 162, etc.) appear at higher frequencies; generally at harmonics of the lowest-frequency “primary” notch 156. The path between devices D1 and D3, being shorter and crossing only one stub, exhibits a lesser notch 166 centered around approximately 2.2 GHz, while the path between devices D1 and D2 exhibits a substantially steady rolloff without significant notches.

Traditionally, the primary notch in a multi-drop signaling system (notch 156 at 1.8 GHz in this example) has either limited the signaling rate over the multi-drop bus or been compensated through relatively complex and expensive equalization schemes, most notably a sufficiently large decision feedback equalization (DFE) circuit. Observing that a number of potential passbands appear above at frequencies beyond the primary notch (e.g., above 2 GHz), an alternative approach employed by embodiments disclosed herein is to include, within the transmitting device, signal transmission circuitry capable of transmitting signals in each of multiple passbands that are separated by notches within the selected communication path, and, within the receiving device, counterpart signal reception circuitry for recovering transmissions from each of the multiple passbands. To facilitate multi-band transmission in this manner, lengths, impedances and/or propagation constants of the lead-in stubs and channel segments may be adjusted (including dynamically-tunable on-chip inductive or capacitive structures that may be adjusted in response to production-time or start-up time programming of register settings within the ICs) as necessary to increase spectral alignment of notches in the various device to device communication paths, and thus tune the various communication paths to establish clearer, higher-margin passbands as shown in FIG. 2C. In the arrangement shown, for example, the center frequency of the first significant notch (notch 166 in FIG. 2B) in the D1-D3 communication path is lowered to coincide with the center frequency of the primary notch (i.e., notch 156 in the D1-D4 communication path) and thus avoid the ˜20 db attenuation at 2.3 GHz that otherwise may apply in D1-D3 communications above 2 GHz. Consequently, as shown in the exemplary frequency response plot of FIG. 2C, multiple, relatively clean passbands, PB1, PB2, PB3, PB4, are formed between progressively-higher-frequency notches, including a passband at baseband (PB1), and multiple higher frequency passbands, PB2, PB3, PB4, etc. FIG. 2D illustrates exemplary modifications to physical dimensions of the channel (e.g., length of ChanSeg23 and Stub3), and placement of one or more additional stubs (e.g., Stub5) to control notch frequency and thus enable notch alignment for a target frequency or set of frequencies as shown in FIG. 2C. As discussed above, in addition to specifically designing the channel segments and stubs (and the addition of terminated or unterminated stubs) to have lengths that yield desired notch frequencies, propagation constants and/or impedances at termination points and/or along the channel pathways may be adjusted to provide notch frequencies in a desired alignment. Note that numerous approaches may be used to tune the channel through adjustment of stub lengths and channel segment lengths including, for example and without limitation, serpentine or other intentionally-extended trace routing schemes, provision of extended or additional vias between circuit board or IC package layers (including selective back-drilling of vias to control via-stubs) and so forth.

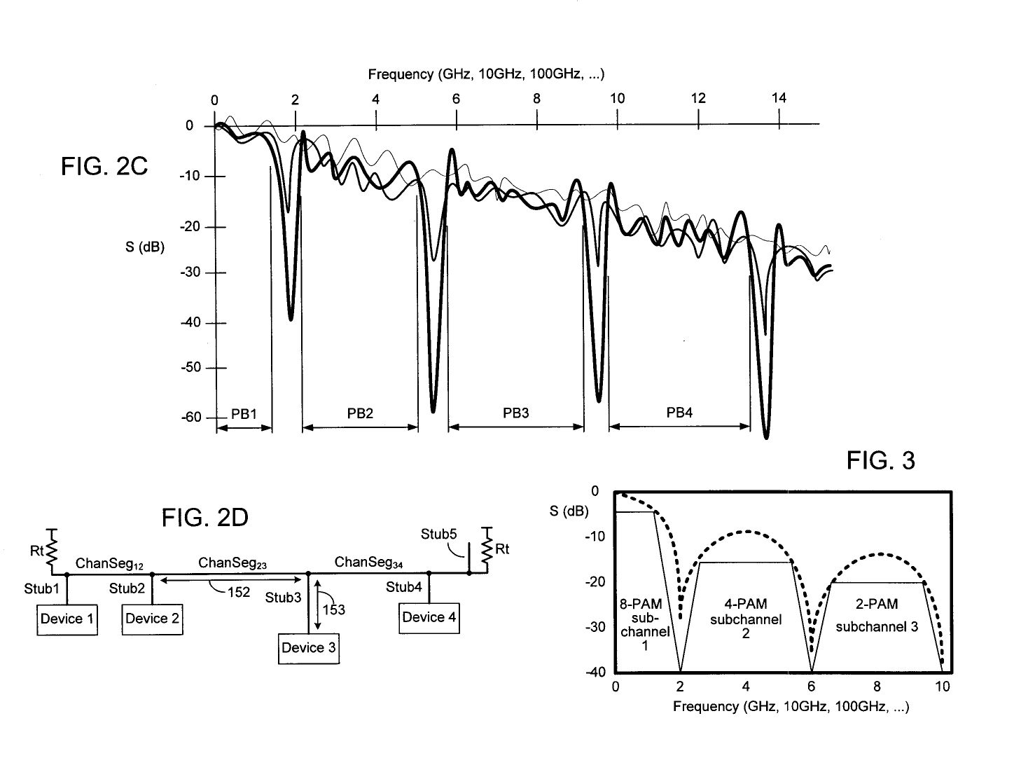

Still referring to FIG. 2C, it can be seen that a relatively linear frequency response curve applies to the passbands such that higher frequency passbands exhibit correspondingly higher attenuation and therefore less signaling margin than lower frequency passbands. In one embodiment, the higher signaling margin in lower-frequency passbands is exploited by employing higher bit-per-symbol encoding in those passbands than in the higher frequency passbands, thus transmitting more data per symbol where the signaling margin allows. In one embodiment, having a subchannel allocation shown, for example, in FIG. 3, each three-bits of transmit data is encoded into one of eight transmitted signal levels (one of eight symbols) by an eight-level pulse-amplitude-modulation (8-PAM) signal driver and transmitted over the baseband subchannel (subchannel 1). By contrast, a second subchannel (subchannel 2) allocated within a higher-frequency, more attenuated passband that provides insufficient margin for 8-PAM signaling, is allocated instead to a 4-PAM (two-bit per symbol) signal driver. Similarly, a third subchannel (subchannel 3) disposed within an even higher-frequency and more attenuated passband that provides insufficient margin for 8-PAM or 4-PAM signaling, is allocated to a 2-PAM (one-bit per symbol) signal driver (note that modulation schemes having more PAM levels and/or more symbols per clock cycle (e.g., quadrature amplitude modulation), may be used in connection with the baseband subchannel or any other of the subchannels that provide sufficient signaling margin for such modulation schemes). In this way, a bandwidth hierarchy may be established among the various subchannels, with progressively lower bit-density signaling protocols being applied in progressively higher-frequency, more attenuated (higher-loss) subchannels. Also, regardless of whether same or different bit-density signaling is applied within the various subchannels, the subchannels may be dynamically allocated to communications between multiple different devices within a signaling system, thereby enabling simultaneous communications between more than two devices (i.e., one device simultaneously communicating with two or communication between devices of one pair simultaneously with communication between devices of one or more other pairs) and/or simultaneous communications in different directions between a pair of devices. The allocation of channels of communication can also be dynamically adjusted on the basis of the current workload requirements of the system. Also, multiple subchannels may be collectively allocated (i.e., ganged) to support a higher-bandwidth communication from one device to another than may be carried out over a single subchannel alone. Such simultaneous communications and ganged-subchannel communications are further discussed below in the context of specific multi-drop signaling topologies.

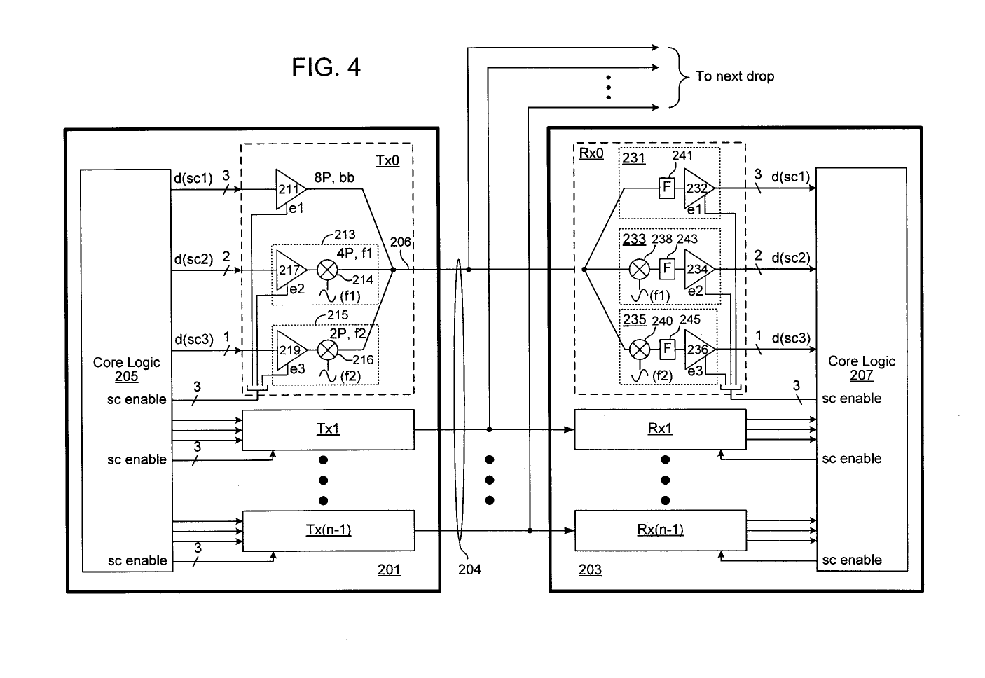

FIG. 4 illustrates a pair of integrated circuit (IC) devices 201 and 203 coupled to one another via a multi-drop bus 204 and including a number of multi-band transmitters, Tx0-Tx(n−1), and counterpart multi-band receivers, Rx0-Rx(n−1), for communicating in one or more of three different passbands tuned to respective center frequencies, 0 (or baseband), f1 and f2. For purposes of explanation, multi-band transmitters are shown in detail only within IC 201 (referred to as a source IC) and multi-band receivers are shown in detail only within IC 203, the destination IC. The source IC 201 may additionally include multi-band receivers (Rx) coupled to the same multi-drop bus (204) as the multi-band transmitters as shown (thus providing multi-band transceivers for each signal line) or to a separate bus (not shown), and the destination IC 203 may similarly include multi-band transmitters (Tx) coupled to multi-drop bus 204 as shown or to separate bus. Also, if desired or necessary for system initialization, side-channel or back-channel communications (e.g., a lower-speed signal link used to convey non-time-critical data such as one-time or periodic configuration information, calibration information, etc.) may be effected over a dedicated signaling path or on one or more links of the multi-drop bus (e.g., by modulation of the common mode of a differential link).

Each of the ICs 201 and 203 includes core logic (205, 207, respectively) which includes circuitry for carrying out the primary function of the IC. For example, in a memory system, in which source IC 201 is a memory controller and destination IC 203 is a memory device (i.e., semiconductor storage device) the core logic of IC 201 may include a memory request queue, address queue, scheduling circuitry, data buffers, or any other circuitry necessary for implementing memory control functions, and the core logic of IC 203 may include a storage array, and interface circuitry for accessing and managing the storage array in response to self-generated and remotely generated memory control commands or requests (e.g., in a dynamic random access memory (DRAM) device, row commands for activating rows and precharging bit lines within a selected bank of storage cells, and column commands for reading and writing selected columns of data within a set of sense amplifiers loaded in response to a row activation command).

In one embodiment, the core logic 205, 207 within each IC includes circuitry to control, during a given transmission interval or set of transmission intervals, which of different subchannels or combinations of subchannels within the aggregate channel (also referred to herein as the superchannel) is allocated to a particular communication. As a matter of terminology, the individual or combined set of subchannels allocated to a particular communication from one IC to another is referred to herein as a virtual channel, and the complete set of subchannels is referred to as the superchannel. Thus, at one extreme, the superchannel is allocated to a single virtual channel to achieve maximum bandwidth for a given transmission (i.e., all subchannels ganged to support a transmission) and, at the other extreme, each subchannel is allocated to a respective virtual channel to enable a maximum number of simultaneous, but distinct communications. Between the fully ganged (allocation of entire superchannel to virtual channel) and fully partitioned (allocation of each subchannel to respective virtual channel) subchannel allocations are various hybrid allocation schemes that include two or more virtual channels, at least one of which is formed by ganged subchannels.

Still referring to FIG. 4 and specifically to the detail view of transmitter Tx0 within source IC 201, each of the transmitters Tx0-Tx(n−1) includes a set of subchannel transmitters 211, 213, 215 that are individually enabled by respective subchannel-enable signals (e1, e2, e3 or, collectively, “sc enable”) from the core logic 205 to transmit a symbol during a given transmit interval. That is, if subchannel-enable signal e1 is asserted during a given transmit interval, 8-PAM (8P) baseband (bb) transmitter 211 (or output driver) is enabled to output an 8-PAM symbol onto signaling link 206. Similarly, if subchannel-enable signal e2 is asserted, 4-PAM (4P) subchannel transmitter 213 having center frequency f1 (pb, f1) is enabled to output a 4-PAM symbol onto signaling link 206, and if subchannel-enable signal e3 is asserted, 2-PAM (2P) passband transmitter 215 having center frequency f2 (pb, f2) is enabled to output a 2-PAM (binary) symbol onto the signaling link 206. Circuitry to enable communication in passbands tuned to respective center frequencies f1 and f2 is illustrated conceptually within transmitters 213 and 215 by mixers 214 and 216, each of which modulates (e.g., multiplies or mixes) a sinusoidal signal with the 4-PAM or 2-PAM pulse train that corresponds to the transmitted data (i.e., supplied by 4-PAM and 2-PAM output drivers 217, 219, respectively). In one embodiment, for example, the mixing operation is effected within an analog circuit (e.g., a Gilbert Quad mixer or the like) that multiplies the data pulse train and a sinusoidal signal. In another embodiment, the mixing operation is implicitly implemented by a fractionally-spaced equalizer (e.g., implemented by a finite impulse response filter) that has a pass-band frequency response tuned to the desired carrier frequency (f1 or f2). More generally, any circuit capable of converting a baseband data signal to a signal tuned to a desired non-zero center frequency may be used to carry out the mixing (or up-conversion or frequency-conversion) operation. Regardless of the circuitry used, the frequency conversion operation may occur before, after or in conjunction with other signaling operations including, for example and without limitation, transmit-pre-emphasis or other pre-shaping equalization to compensate for channel imperfection, or filtering to effect single-side-band communication or remove other images or spectral components of the output signal. Frequency conversion circuits (e.g., mixing circuits 214 and 216) may be disabled when the subchannel enable signals e2 and e3 are deasserted. Also, while multi-band communication has been described with reference to individual sub-channels having fixed spectral allocations, the sub-channel frequencies may be adjustable, for example to account for (or track or match) adjustments to individual notches in different signaling systems.

Note that the core logic within IC 201 and/or IC 203 may include equalizers or other circuitry that compensates for the ISI in the individual sub-channels and/or for the interference between the sub-channels (both in the Tx and in the Rx). Also, the mixing function described above may alternatively be implemented in digital domain as part of the core logic. In multi-band transmission in particular, over-sampled equalizers may be provided for each channel to carry out mixing, per-channel equalization and inter-channel interference cancellation operations, all at the same time. At the receiver, multi-input/multi-output decision-feedback equalizing (MIMO DFE) may be provided. More generally, the transmission circuitry, receive circuitry and/or core logic may include any circuitry that enables signal processing on the individual channels to be optimized in conjunction with the other sub-channels to achieve optimal or at least improved performance.

Referring to the detail view of receiver Rx0 within destination IC 203, each of the receivers Rx0-Rx(n−1) includes a set of subchannel receivers 231, 233, 235 that are individually enabled by respective subchannel enable signals (e1, e2, e3) from the core logic circuit to sample the incoming signal during a given reception interval. That is, if subchannel-enable signal e1 is asserted during a given transmit interval, 8-PAM (8P) baseband (bb) receiver 231 is enabled to sample an 8-PAM symbol conveyed on signaling link 206 by counterpart 8-PAM transmitter 211. Similarly, if subchannel-enable signal e2 is asserted, 4-PAM (4P) passband receiver 233, tuned to center frequency f1, is enabled to sample a 4-PAM symbol conveyed on signaling link 206 by counterpart 2-PAM passband transmitter 213, and if subchannel-enable signal e3 is asserted, 2-PAM (2P) passband receiver 235, tuned to center frequency f2, is enabled to sample a 2-PAM symbol conveyed on the signaling link 206 by counterpart 2-PAM transmitter 215. As with passband transmitters 213 and 215, circuitry to enable signal reception in passbands tuned to center frequencies f1 and f2 is illustrated conceptually by mixers 238 and 240, each of which demodulates (e.g., multiplies or mixes) a sinusoid signal with the incoming 4-PAM or 2-PAM pulse train to down-convert the transmission to baseband. Low-pass filters 243 and 245 are provided to filter undesired spectral components that result from sinusoidal modulation (i.e., at frequency 2*f1 or 2*f2) and also to filter spectral components that correspond to transmission in other passbands. A filter 241 may also be provided at the input of subchannel receiver 231 (i.e., the baseband receiver) to filter such undesired spectral components. For example, in one embodiment, an “integrate and dump” filter may be provided to integrate over one or more sub-channel periods (or a fraction of a sub-channel period), though other types of filters may be used. After demodulation (except in the baseband path) and filtering, the baseband symbols corresponding to the various subchannels are selectively sampled by respective baseband sampling circuits 232, 234, 236 (i.e., depending on whether the corresponding subchannel enable signal is asserted) that operate, for example, by converting n-PAM symbols into log 2(n) received data bits. In the particular implementation shown, for example, sampling circuit 232 recovers three data bits, d(sc1), from each 8-PAM symbol, sampling circuit 234 recovers two data bits, d(sc2), from each 4-PAM symbol and sampling circuit 236 recovers one data bit, d(sc3) from each 2-PAM symbol. As with the pass band transmitters 213 and 215, the mixing operations performed by mixers 238 and 240 may be carried out by an analog mixing circuit, a fractionally-spaced equalizer or any other circuit capable of demodulating the modulated-carrier input signal. Also, the mixing operation may occur before, after or in conjunction with other signaling operations including, for example and without limitation, the filtering operations performed by filters 243, 245, linear equalization and/or decision-feedback equalization (DFE) operations. Further, while FIG. 4 depicts analog signal processing, an analog-to-digital converter (ADC) may be provided at the front end to digitize incoming signals so that mixing, filtering, equalization or any other signal processing operations or subset thereof are performed in the digital domain.

In one embodiment, subchannel allocation logic is provided within the core logic 205, 207 of the source and destination ICs to assert the subchannel-enable signals in any combination according to communication needs within the signaling system, thus enabling, in this embodiment, one or more of the three subchannels (baseband, passband at f1 (PB1) and passband at f2 (PB2)) to be allocated for symbol transmission in a given transmit interval, thus enabling transmission over a single selected subchannel or ganged transmission over any pair of subchannels or all three subchannels as follows:

TABLE 1

| | | | allocated | bits conveyed |
|---|---|---|---|---|
| e3 | e2 | e1 | subchannels | tx interval |
| 0 | 0 | 0 | none | none |
| 0 | 0 | 1 | BB | 3 |
| 0 | 1 | 0 | PB1 | 2 |
| 0 | 1 | 1 | BB, PB1 | 5 |
| 1 | 0 | 0 | PB2 | 1 |
| 1 | 0 | 1 | BB, PB2 | 4 |
| 1 | 1 | 0 | PB1, PB2 | 3 |
| 1 | 1 | 1 | BB, PB1, PB2 | 6 |

As with other embodiments described herein, the particular number of sub-channels per link, bit-densities per sub-channel, number of signaling links, etc. shown in FIG. 4 are provided for purposes of example only and may be different in alternative embodiments, provided that there is a minimum of two sub-channels to enable multi-band signaling. Also, in an embodiment in which all or some combination of subchannels are always ganged for a given inter-device communication, the subchannel-enable lines and logic for controlling same may be omitted (e.g., all subchannel transmitters enabled as a group in response to a transmit clock signal or other triggering signal, not shown). Further, although not specifically shown, timing circuitry for controlling symbol transmission and reception times may be provided within the source and destination ICs 201, 203 to enable synchronous transmission and reception. For example, in a master slave system, a master clock signal generated within a master device (e.g., source IC 201) may be used to generate a transmit and receive clock signal within that device, and also output to the destination device (i.e., a slave device) to enable synchronous symbol reception and transmission therein. For example, in one embodiment, the master clock signal may be provided as a mesochronous reference clock signal to a clock-data-recovery circuit within the receivers Rx0-Rx(n−1) of the destination IC 203 to enable generation of one or more sampling clock signals and/or transmit clock signals. Alternatively, each device may include its own clock source (or receive respective reference clock signals) and the master clock used, as a plesiochronous timing reference, to enable phase adjustment of the local clock source as necessary to establish phase and/or frequency locked clocking within the source and destination devices.

Still referring to FIG. 4, to support the dynamic subchannel allocation shown, the subchannel allocation circuitry within the source IC 201 may issue commands to the destination IC 203 (e.g., via a sideband communication path or via a dedicated, always-enabled subchannel) to notify the destination IC 203 that communication on a particular subchannel or collection of subchannels is in fact directed to the destination IC. The allocation circuitry within the destination IC may respond to the incoming notification information (or commands) by asserting subchannel-enable signals (“sc enable”) as necessary to enable data reception via the specified subchannels. Arbitration circuitry for allocating subchannels and/or enabling subchannel communication may also be provided within a device separate from the source and destination devices, particularly in the case of a peer-to-peer signaling system, or in a master-slave signaling system having multiple master devices.

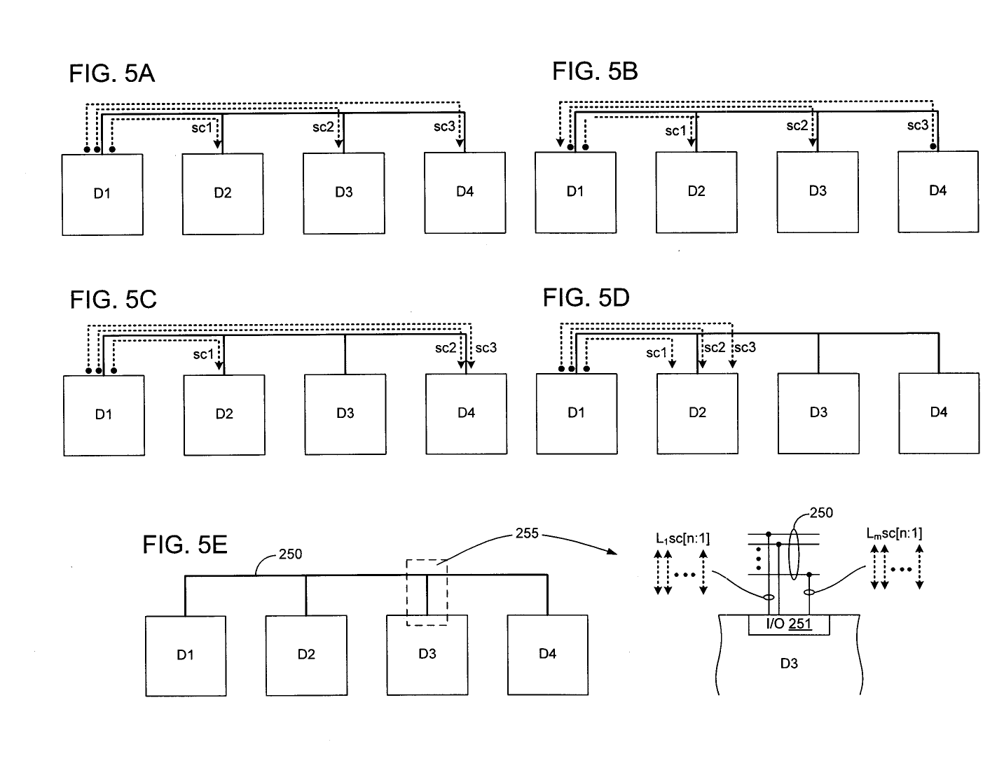

FIGS. 5A-5D illustrate a number of possible virtual channel allocations in a multi-drop signaling system having a superchannel formed by multiple spectrally defined subchannels and/or multiple spatially defined subchannels. In FIG. 5A, for example, device 1 (D1) transmits data simultaneously to each of devices 2, 3 and 4 (D2, D3 and D4) via respective spectrally defined (i.e., tuned to different center frequency) subchannels sc1, sc2 and sc3 (i.e., each subchannel constitutes a respective virtual channel). In FIG. 5B, D1 transmits to each of devices D2 and D3, while D4 simultaneously transmits to D1 (or to D2 or D3). Thus, each subchannel still constitutes a respective virtual channel, but at least one of the virtual channels is driven by a different device than at least one other of the virtual channels (three different devices may also be enabled to transmit data instead of the two shown). In FIG. 5C, subchannels sc2 and sc3 are ganged to form a virtual channel for transmission from D1 to D3 while, simultaneously, subchannel sc1 alone constitutes a virtual channel for transmission from D1 to D2. Note that different transmission sources may apply in the example of FIG. 5C (e.g., D2 may transmit to D3 via sc1 concurrently with transmission from D1 to D4 via the virtual channel formed by sc2 and sc3). Finally, FIG. 5D illustrates a fully ganged arrangement, in which a single virtual channel formed by sc1, sc2 and sc3 is allocated to support transmission between a pair of devices (D1 and D2 in this example). Virtual channel allocation in this manner enables dynamic reconfiguration (e.g., on-the-fly changes) of the signaling system to best meet communication load demands.

The dynamic virtual channel allocation illustrated in FIGS. 5A-5D may be extended across multiple signaling links that form one or more signaling buses between devices D1-D3, thereby providing a spatial axis of subchannel allocation. For example, as shown in FIG. 5E, the multi-drop signaling path 250 extending between integrated circuit devices D1-D4 (or even separate circuits on a common integrated circuit die) may include multiple signaling links (M) on which virtual channels may be individually allocated as shown in FIGS. 5A-5D. More specifically, as shown in detail view 255 which depicts the I/O interface 251 of integrated circuit device D3 and its multi-link connection to signaling path 250, the individual subchannels (sc₁-scₙ) any two or more of the links (L₁-Lₘ) may be allocated to the same virtual channel or different virtual channels to provide an additional axis of virtual channel allocation. Thus, at any given time, all the spectrally-defined (i.e., spectrally-differentiated) subchannels on all the signaling links (m*n sub-channels in all), may be allocated to a single virtual channel such that the entire superchannel is allocated to a single virtual channel, or each of the spectrally-defined subchannels on each of the signaling links may be allocated to a respective virtual channel, to the extent that the number of possible virtual channels meets or exceeds the total number of allocable subchannels (i.e., m*n subchannels). Accordingly, virtual channels may be formed by subchannel allocations in at least three independent dimensions: a spatial dimension with ganged or independent allocations of spatially-defined subchannels (e.g., signaling links); a spectral dimension with ganged or independent allocations of spectrally-defined channels; and/or a temporal dimension with the spatial/spectral subchannel allocation being adjusted (changed) at any practicable frequency, down to reallocation of subchannels at each successive transmission interval. As discussed above, centralized arbitration logic (e.g., arbitration circuitry disposed on a master device), distributed arbitration logic (as in a token passing arrangement) or any combination of centralized and distributed arbitration logic may be provided to dynamically allocate subchannels as needed, for example, to meet peak bandwidth needs, avoid resource conflicts, prioritize transmissions and so forth. Also, circuitry and protocols for detecting and managing error detection and/or resource conflicts may be applied (e.g., as part of or in association with arbitration logic) to manage signal re-transmission and corresponding subchannel allocation according to system needs.

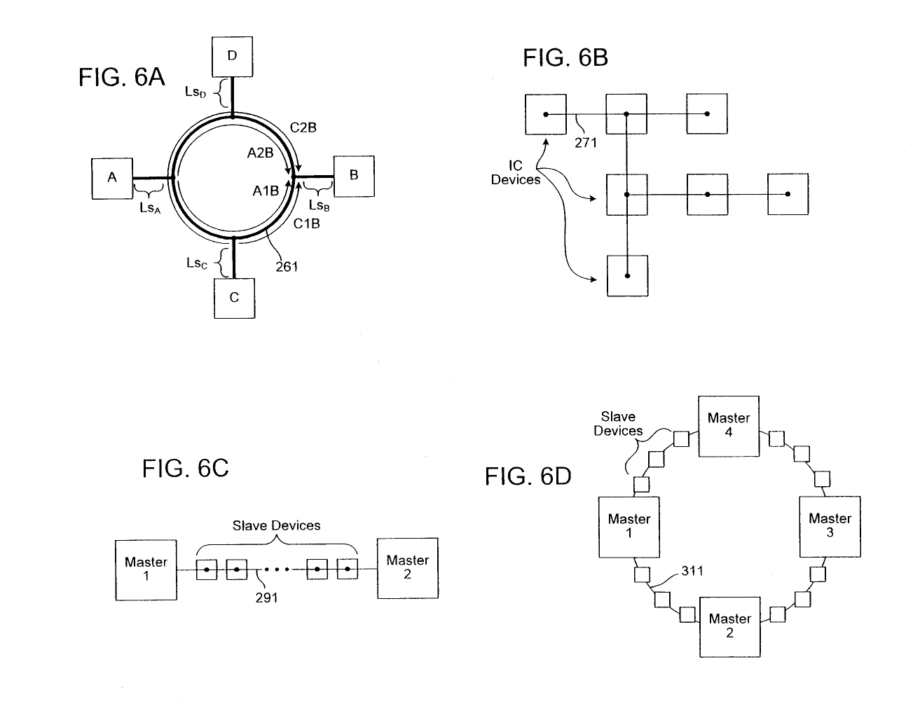

As discussed briefly above, because notches resulting from multi-drop signaling arrangements may be tuned to achieve selected passbands, numerous otherwise avoided multi-drop signaling topologies may be employed in conjunction with subchannel signaling. FIG. 6A, for example illustrates a number of IC devices (A, B, C, D) interconnected via a multi-drop bus 261 disposed in a ring (i.e., a “ring bus”, which may be disposed in a circular ring, square ring, diamond ring or any other shape in which the path from a device to the adjacent device is N−1 times longer in one direction (clockwise or counterclockwise) than the other, N being the number of IC devices in the ring). As in embodiments described above, lead-in stub lengths (Ls_{A}, Ls_{B}, Ls_{C}, Ls_{D}), impedances and/or propagation constants may be tuned (e.g., by selection of specified physical lengths, by addition of or adjustment of tuning structures, or by adjustment of on-chip structures or circuits used to tune the lead-in impedance) to establish a desired set of passbands for subchannel signaling. As shown, the ring bus 261 enables each IC device to communicate with any other IC device via both clockwise and counter-clockwise paths around the ring. For example, device C may transmit to device B via counter-clockwise path C1B and also via clockwise path C2B. The resulting waveform received at B is thus the superposition of the waveforms traveling in the clockwise and counter-clockwise direction. The length of the traces in between the stub connections to the ring bus 261, and the length of the stubs connecting the devices to the ring-bus can be tuned to form the characteristics of the communication channel between C and B. In one embodiment, the length of the counter-clock wise trace between C and B is ⅓ of the clock-wise trace between C and B while the lengths of the clockwise and counter-clock wise paths from A to B and C to D are equal. This way the turn around reflection time along C1B is ⅓ the reflection turn around time in the opposite direction along C2B. Since reflections lead to resonance frequencies that repeat at odd multiples of a fundamental first resonance frequency, the resonance frequencies arising from the two reflection paths coincide, and therefore, lead to a channel characteristic with equally spaced notch frequencies. This kind of frequency response with equally spaced notch frequencies is optimal for certain multi-tone transmission techniques including Analog Multi-Tone. The absence of termination resistors in the ring structure leads to higher received signal energy at the receiver compared to a conventionally terminated linear structure.

Similarly to the C-to-B path, device A may transmit to device B via counter-clockwise path A1B and via clockwise path A2B. In this signaling path both A1B and A2B signals superimpose at the receiver of device B at approximately the same time, allowing for a signal which would be both phase aligned and is clearly twice as large as that of a conventionally terminated system. In different embodiments of the ring topology, termination can be accomplished at the transmitter or receiver devices only, or at the transmitter and receiving device, or at the transmitter and all receiving devices.

FIG. 6B illustrates an embodiment of a subchannel signaling system having a number of IC devices interconnected via a multi-drop bus 271 in the form of a tree structure. That is, a number of the IC devices are disposed along branches of the tree (each formed by a ‘T’ in the bus), while other IC devices are disposed at leaf nodes of the tree (i.e., at ends of the bus). As in embodiments described above, lead-in stubs for any or all of the IC devices coupled to bus 271 may be tuned (e.g., by selection of specified physical lengths, characteristic impedances and/or propagation constants, by addition of or adjustment of tuning structures, or by adjustment of on-chip structures or circuits used to tune the lead-in impedance) to achieve a desired set of passbands to support subchannel signaling. Given that a multi-drop virtual channel can now support three or more nodes, it becomes possible to build a tree network of different configurations and distances between devices. Such a tree network can be used to facilitate signaling paths between two different leaves which do not need to return to the main trunk. For example, in a network switching device, a signaling path may be established from one line card to another without having to route through the switch-card. Such topologies are generally possible with baseband-only signaling at much lower data rates and without the proliferation of different virtual channels available by using multi-band signaling.

FIG. 6C illustrates an embodiment of a subchannel signaling system having a multi-drop bus 291 that extends between two master devices, Master 1 and Master 2, with slave devices coupled to the bus at points along its length. In one embodiment, for example, the master devices are CPU devices and the slave devices are shared memory devices, though numerous other master/slave possibilities exist. As with embodiments described above, lead-in stub lengths may be tuned to establish a desired set of passbands to support subchannel signaling. In one embodiment, for example, distinct virtual channels (each formed by one or more subchannels) may be statically or dynamically allocated to each of the master devices, thereby permitting the master devices to simultaneously communicate with the slave devices. In the case of dynamic subchannel allocation, arbitration logic may be provided within one of the master devices to respond to subchannel acquisition requests and allocate subchannels to each of the master devices as needed. Alternatively, a token passing scheme may be used to exchange control of subchannel allocation between the master devices from time to time or in response to selected events or system conditions.

FIG. 6D illustrates yet another embodiment of a multi-subchannel signaling system formed by multiple master devices (Master 1, Master 2, Master 3, Master 4) coupled to a ring-type multi-drop bus 311, with one or more slave devices coupled to the bus between each pair (or at least one of the pairs) of master devices. As with the system of FIG. 6C, distinct virtual channels may be statically or dynamically allocated to each of the master devices, with subchannel allocation being managed by arbitration circuitry within one or a subset of the master devices, or by shared control between each of the master devices (e.g., a token passing scheme in which arbitration circuitry within each of the master devices or any subset thereof obtains temporary control over subchannel allocation before relinquishing control to another master device). In this embodiment it should be noted that there exists a hierarchy of communication between a master device and different slave devices. Slave devices closer to the master will have lower latency as well as potentially less interference and thus higher-bandwidth communication paths to the adjacent master than they will to a master many devices away.

It should be noted that the various circuits disclosed herein may be described using computer aided design tools and expressed (or represented), as data and/or instructions embodied in various computer-readable media, in terms of their behavioral, register transfer, logic component, transistor, layout geometries, and/or other characteristics. Formats of files and other objects in which such circuit expressions may be implemented include, but are not limited to, formats supporting behavioral languages such as C, Verilog, and VHDL, formats supporting register level description languages like RTL, and formats supporting geometry description languages such as GDSII, GDSIII, GDSIV, CIF, MEBES and any other suitable formats and languages. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.).

When received within a computer system via one or more computer-readable media, such data and/or instruction-based expressions of the above described circuits may be processed by a processing entity (e.g., one or more processors) within the computer system in conjunction with execution of one or more other computer programs including, without limitation, net-list generation programs, place and route programs and the like, to generate a representation or image of a physical manifestation of such circuits. Such representation or image may thereafter be used in device fabrication, for example, by enabling generation of one or more masks that are used to form various components of the circuits in a device fabrication process.

In the foregoing description and in the accompanying drawings, specific terminology and drawing symbols have been set forth to provide a thorough understanding of the present invention. In some instances, the terminology and symbols may imply specific details that are not required to practice the invention. For example, any of the specific numbers of bits, signal path widths, signaling or operating frequencies, component circuits or devices and the like may be different from those described above in alternative embodiments. Also, the interconnection between circuit elements or circuit blocks shown or described as multi-conductor signal links may alternatively be single-conductor signal links, and single conductor signal links may alternatively be multi-conductor signal links. Signals and signaling paths shown or described as being single-ended may also be differential, and vice-versa. Similarly, signals described or depicted as having active-high or active-low logic levels may have opposite logic levels in alternative embodiments. Component circuitry within integrated circuit devices may be implemented using metal oxide semiconductor (MOS) technology, bipolar technology or any other technology in which logical and analog circuits may be implemented. With respect to terminology, a signal is said to be “asserted” when the signal is driven to a low or high logic state (or charged to a high logic state or discharged to a low logic state) to indicate a particular condition. Conversely, a signal is said to be “deasserted” to indicate that the signal is driven (or charged or discharged) to a state other than the asserted state (including a high or low logic state, or the floating state that may occur when the signal driving circuit is transitioned to a high impedance condition, such as an open drain or open collector condition). A signal driving circuit is said to “output” a signal to a signal receiving circuit when the signal driving circuit asserts (or deasserts, if explicitly stated or indicated by context) the signal on a signal line coupled between the signal driving and signal receiving circuits. A signal line is said to be “activated” when a signal is asserted on the signal line, and “deactivated” when the signal is deasserted. Additionally, the prefix symbol “/” attached to signal names indicates that the signal is an active low signal (i.e., the asserted state is a logic low state). A line over a signal name (e.g., ‘ <̅s̅i̅g̅n̅a̅l̅ n̅a̅m̅e̅>̅’) is also used to indicate an active low signal. The term “coupled” is used herein to express a direct connection as well as a connection through one or more intervening circuits or structures. Integrated circuit device “programming” may include, for example and without limitation, loading a control value into a register or other storage circuit within the device in response to a host instruction and thus controlling an operational aspect of the device, establishing a device configuration or controlling an operational aspect of the device through a one-time programming operation (e.g., blowing fuses within a configuration circuit during device production), and/or connecting one or more selected pins or other contact structures of the device to reference voltage lines (also referred to as strapping) to establish a particular device configuration or operation aspect of the device. The term “exemplary” is used to express an example, not a preference or requirement.

While the invention has been described with reference to specific embodiments thereof, it will be evident that various modifications and changes may be made thereto without departing from the broader spirit and scope of the invention. For example, features or aspects of any of the embodiments may be applied, at least where practicable, in combination with any other of the embodiments or in place of counterpart features or aspects thereof. Accordingly, the specification and drawings are to be regarded in an illustrative rather than a restrictive sense.

1-28. (canceled)

29. In a system comprising a memory controller coupled to first and second memory devices via a multi-drop transmission line, the system comprising:
a first communication path along a portion of the transmission line spectrally exhibiting a first group of passbands separated by a first set of one or more attenuation notches, the first communication path comprising a first segment coupled to the controller and first memory device via respective first and second stubs;
a second communication path along the transmission line spectrally exhibiting a second group of passbands separated by a second set of one or more attenuation notches, the second communication path comprising a second segment and coupled to the controller and the second memory device via the first stub and a third stub, respectively;
wherein the first, second and third stubs electrically cooperate with each other and the first and second segments such that the first set of one or more attenuation notches is spectrally aligned with the second set of one or more attenuation notches.

30. The system according to claim 29 wherein the memory controller comprises:
baseband transmitter circuitry to transmit baseband signals within a baseband range of frequencies defined by the spectrally aligned one or more attenuation notches; and
passband transmitter circuitry to transmit passband signals within a first passband range of frequencies defined by the spectrally aligned one or more attenuation notches, the first passband range of frequencies separate from the baseband range of frequencies.

31. The system of claim 30 wherein:
the first memory device comprises baseband receiver circuitry to receive the baseband signals from the memory controller; and
the second memory device comprises passband receiver circuitry to receive the passband signals from the memory controller.

32. The system of claim 31 wherein:
the first memory device further comprises passband receiver circuitry;
the second memory device further comprises baseband receiver circuitry; and
the first and second memory devices receive signals at one or both of the baseband and passband range of frequencies.

33. The system of claim 32 wherein the memory controller comprises:
core logic for dynamically allocating bandwidth between the memory controller and the first and second memory devices over the first and second communication paths.

34. The system of claim 29 wherein one or more electrical properties exhibited by at least one of the first, second and third stubs and the first and second segments are adjustable.

35. A method of signaling between a memory controller and respective first and second memory devices coupled to a multi-drop bus via respective stubs, the multi-drop bus comprising first and second transmission line segments, the method comprising:
establishing a first communication path between the memory controller and the first memory device, the first communication path spectrally exhibiting a first group of passbands separated by a first set of one or more attenuation notches;
establishing a second communication path between the memory controller and the second memory device, the second communication path spectrally exhibiting a second group of passbands separated by a second set of one or more attenuation notches; and
spectrally aligning the first set of one or more attenuation notches with the second set of one or more attenuation notches by configuring at least one of the respective stubs and first and second transmission line segments to electrically cooperate together in a deterministic manner.

36. The method according to claim 35 and further including:
transmitting a signal from the memory controller to one of the memory devices within a baseband frequency range defined by the spectral aligning; and
transmitting a signal from the memory controller to the other of the memory devices within a passband frequency range defined by the spectral aligning, the passband frequency range being separate from the baseband frequency range.

37. The method according to claim 35 and further including:
dynamically allocating the baseband and passband frequency ranges defined by the spectral aligning between the memory controller and the first and second memory devices.

38. A chip to chip signaling system including:
a transmission line;
a master integrated circuit (IC) device coupled to the transmission line;
a plurality of slave IC devices coupled to the transmission line to define a multi-drop bus, wherein each of the plurality of slave IC devices communicates with the master IC device via respective communication paths, each communication path exhibiting multiple tones corresponding to separate signal subchannels; and
wherein the master IC device includes core logic to dynamically allocate the separate signal subchannels between the master IC device and slave IC devices.

39. The chip to chip signaling system according to claim 38 wherein:
the core logic dynamically allocates subchannels to effect simultaneous communications between the master IC device and one or more slave IC devices.

40. The chip to chip signaling system according to claim 38 wherein:
the dynamic allocation effects simultaneous communication in different directions between the master IC device and one of the slave IC devices.

41. The chip to chip signaling system of claim 38 wherein:
the core logic dynamically allocates subchannels collectively to support a higher bandwidth communication from the master IC device to at least one of the slave IC devices.

42. The chip to chip signaling system of claim 38 wherein:
the dynamic allocation is based at least in part on the current workload requirements of the system.

43. A method of signaling between a master IC device coupled to a multi-drop transmission line, and a plurality of slave IC devices coupled to the multi-drop transmission line, the method comprising:
establishing respective communication paths between the master IC device and the plurality of slave IC devices, each communication path exhibiting multiple tones corresponding to separate signal subchannels;
dynamically allocating the separate signal subchannels between the master IC device and the slave IC devices.

44. The method according to claim 43 wherein dynamically allocating comprises:
simultaneously communicating between the master IC device and one or more slave IC devices.

45. The method according to claim 43 wherein dynamically allocating comprises:
simultaneously communicating in different directions between the master IC device and one of the slave IC devices.

46. The method according to claim 43 wherein dynamically allocating comprises:
collectively allocating subchannels to support a higher bandwidth communication from the master IC device to at least one of the slave IC devices.

47. The method according to claim 43 wherein dynamically allocating is based at least in part on the current workload requirements of the system.

48. A transmission line comprising:
a first communication path spectrally exhibiting a first group of passbands separated by a first set of one or more attenuation notches, the first communication path comprising a first segment having ends;
first and second stubs, wherein the first segment is coupled at each end to the first and second stubs, respectively;
a second communication path spectrally exhibiting a second group of passbands separated by a second set of one or more attenuation notches, the second communication path comprising a second segment having ends;
a third stub, wherein the second segment is coupled at each end to the first stub and the third stub, respectively;
wherein the first, second and third stubs electrically cooperate with each other and the first and second segments such that the first set of one or more attenuation notches is spectrally aligned with the second set of one or more attenuation notches.

49. The transmission line of claim 48 wherein the first communication path includes a proximal end of the transmission line and the second communication path includes a distal end of the transmission line, the transmission line further including:
at least one termination resistor disposed at the proximal or distal end of the transmission line.

50. The system of claim 48 wherein one or more electrical properties exhibited by at least one of the first, second and third stubs and the first and second segments are adjustable.
